(19) United States
(12) Patent Application Publication
(10) Pub. No.: US 2016/0182273 A1
(43) Pub. Date: Jun. 23, 2016

(54) METHOD AND APPARATUS OF 128-DSQ DE-MAPPING IN 10GBASE-T SYSTEM

(71) Applicant: QUALCOMM INCORPORATED, San Diego, CA (US)

(72) Inventors: Jian Li, Beijing (CN); Fuyun Ling, San Diego, CA (US); Changlong Xu, Beijing (CN); Yin Huang, Beijing (CN); Yisheng Xue, San Diego, CA (US); Jilei Hou, Beijing (CN)

(21) Appl. No.: 14/910,569

(22) PCT Filed: Sep. 10, 2013
(86) PCT No.: PCT/CN2013/083203

§ 371 Date: Feb. 5, 2016

(51) Int. Cl. H04L 27/38; H04L 1/00

(52) U.S. Cl. CPC H04L 27/38; H04L 1/0054

(57) ABSTRACT

A method and apparatus for demapping a double squared quadrature amplitude modulated (DSQ) symbol is disclosed. One or more first log likelihood ratios (LLRs) are determined, for a first subset of constellation points of a corresponding DSQ constellation, using an LLR approximation. One or more second LLRs are determined, for a second subset of constellation points of the DSQ constellation, using a lookup table. The DSQ symbol is then demapped to one of a plurality of constellation points of the DSQ constellation based on the first and second LLRs. For some embodiments, the first subset of constellation points may correspond with an inner region of the DSQ constellation and the second subset of constellation points may correspond with an outer region of the DSQ constellation.

### TECHNICAL FIELD

The present embodiments relate generally to communications systems, and specifically to communications systems that use DSQ data modulation techniques.

### BACKGROUND OF RELATED ART

In 10GBASE-T Ethernet applications, a 128-DSQ (Double Squared QAM) constellation is used to achieve a higher coding gain from a denser constellation packaging. FIG. 1 shows an exemplary DSQ constellation 100 which may be used for mapping and/or de-mapping labeling bits transmitted over a 10GBASE-T Ethernet system. Each constellation point 101 maps to 7 labeling bits, including 4 low density parity check (LDPC) encoded bits and 3 unencoded bits. A received DSQ symbol is demapped by first calculating a log-likelihood ratio (LLR) for the 4 coded bits. The 3 unencoded bits may then be determined using hard decision logic.

For example, given the DSQ constellation 100 shown in FIG. 1, an exact LLR can be calculated based on the equation:

$$LLR ( x ) = log \frac{{\sum }_{i = 0}^{63} exp ( \frac{{\vert r - {x [ i ]}^{0} \vert}^{2}}{2 {σ}^{2}} )}{{\sum }_{i = 0}^{63} exp ( \frac{{\vert r - {x [ i ]}^{1} \vert}^{2}}{2 {σ}^{2}} )} \qquad ( 1 )$$

where r corresponds to the received symbol, and x[i]⁰ and x[i]¹ represent the constellation sets corresponding to logic 0 and logic 1 bits, respectively. However, implementing the LLR equation above (i.e., Equation 1) may not be practical for high speed hardware applications due to the extensive amount of exponential and logarithmic computations involved. It is therefore desirable to find a more simple yet accurate way of demapping a received DSQ symbol, while maintaining a relatively high coding gain.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of operation are disclosed that may aid in the demapping of double squared quadrature amplitude modulated (DSQ) symbols. Upon receiving a DSQ symbol, one or more first log likelihood ratios (LLRs) are determined for a first subset of constellation points of a corresponding DSQ constellation using an LLR approximation. One or more second LLRs are determined for a second subset of constellation points of the DSQ constellation using a lookup table. The received DSQ symbol is then demapped to one of a plurality of constellation points of the DSQ constellation based on the first and second LLRs. For some embodiments, a signal space (x, y) associated with the DSQ constellation may be rotated, and the first and second LLRs may be determined based on the rotated signal space (x′, y′). For example, the rotated signal space may be defined as: x′=(x−y)/4 and y′=(x+y)/4.

For some embodiments, the DSQ constellation may be a 128-DSQ constellation for 10GBASE-T Ethernet, wherein each constellation point maps to 7 labeling bits (e.g., 4 encoded bits and 3 unencoded bits). Furthermore, the first subset of constellation points may correspond with an inner region of the DSQ constellation and the second subset of constellation points may correspond with an outer region of the DSQ constellation, wherein the inner and outer regions of the DSQ constellation are delineated by: |x′±y′|=7.

For some embodiments, the LLR approximation used for determining the one or more first LLRs may be a max-log LLR approximation. For example, the one or more first LLRs may be determined by calculating:

$$LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix}$$

For some embodiments, the lookup table may store information identifying a two-dimensional grid pattern, wherein each of the plurality of constellation points coincides with a cross-point of the grid pattern. Furthermore, the one or more second LLRs may be determined by: identifying a particular grid of the two-dimensional grid pattern based on the DSQ symbol; performing a two-dimensional interpolation of the four cross-points that define the particular grid; and calculating the one or more LLRs based on the interpolation. For example, the one or more second LLRs may be determined by calculating:

$$LLR ( {x}^{′} , {y}^{′} ) = \frac{\{ ( {x}^{′} - {a}_{i} ) * LLR ( i + 1 , j ) + ( {a}_{i + 1} - {x}^{′} ) * LLR ( I , j ) \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )}$$

It should be noted that the LLR equation used to determine the one or more second LLRs is much simpler than the exact LLR equation (i.e., Equation 1) described previously. Moreover, because the corresponding grid pattern may be stored in a look-up table, the one or more second LLRs may be more easily implemented in high speed Ethernet hardware (e.g., than conventional LLR calculation techniques). Accordingly, the present embodiments provide an efficient technique for demapping a received DSQ symbol to constellation points of a DSQ constellation that is accurate for calculating LLRs throughout the entire DSQ constellation.

### BRIEF DESCRIPTION OF THE DRAWINGS

The present embodiments are illustrated by way of example and are not intended to be limited by the figures of the accompanying drawings, where:

FIG. 1 shows an exemplary DSQ constellation that may be used in 10GBASE-T Ethernet Applications;

FIG. 2 shows a communications system in accordance with some embodiments;

FIG. 3 shows a block diagram of a receiver with region-based DSQ demapping circuitry in accordance with some embodiments;

FIG. 4 shows a block diagram of a region-based DSQ demapper in accordance with some embodiments;

FIG. 5A shows an exemplary DSQ constellation that is rotated and subdivided in accordance with some embodiments;

FIG. 5B shows an exemplary DSQ constellation that is rotated and subdivided in accordance with other embodiments;

FIG. 6 shows an exemplary grid pattern that may be used to generate a lookup table in accordance with some embodiments;

FIG. 7 is an illustrative flow chart depicting a region-based DSQ demapping operation in accordance with some embodiments; and

FIG. 8 shows a block diagram of a demapper in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

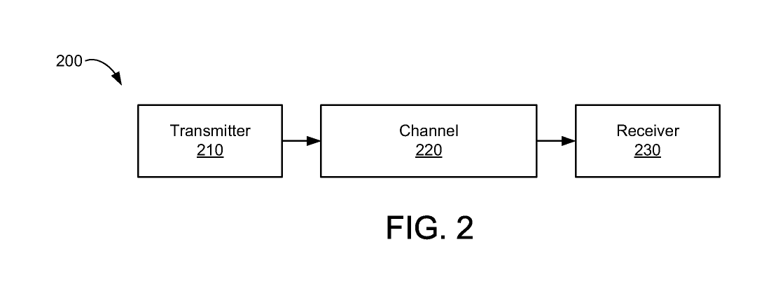

FIG. 2 shows a communications system 200 in accordance with some embodiments. A transmitter 210 transmits a signal onto a channel 220, and a receiver 230 receives the signal from the channel 220. The transmitter 210 and receiver 230 may be, for example, computers, switches, routers, hubs, gateways, and/or similar devices. In some embodiments, the channel 220 is wireless. In other embodiments, the channel 220 is a wired link (e.g., a coaxial cable or other physical connection).

Imperfections of various components in the communications system 200 may become sources of signal impairment, and may thus cause signal degradation. For example, imperfections in the channel 220 may introduce channel distortion, which may include linear distortion, multi-path effects, and/or Additive White Gaussian Noise (AWGN). To combat potential signal degradation, the transmitter 210 and the receiver 230 may implement low density parity check (LDPC) encoding and decoding operations in combination with double squared quadrature amplitude modulation (DSQ) mapping and demapping techniques. For example, the transmitter 210 may map a set of labeling bits to a DSQ constellation point (or “symbol”) which may be transmitted to, and subsequently demapped by, the receiver 230. For some embodiments, the receiver 230 may implement different demapping techniques for different regions of the DSQ constellation. More specifically, the receiver 230 may use a log likelihood ratio (LLR) approximation when comparing the received DSQ symbol to constellation points that are relatively close to the origin (i.e., the center of the DSQ constellation), and use a lookup table when comparing the DSQ symbol to constellation points that are further away.

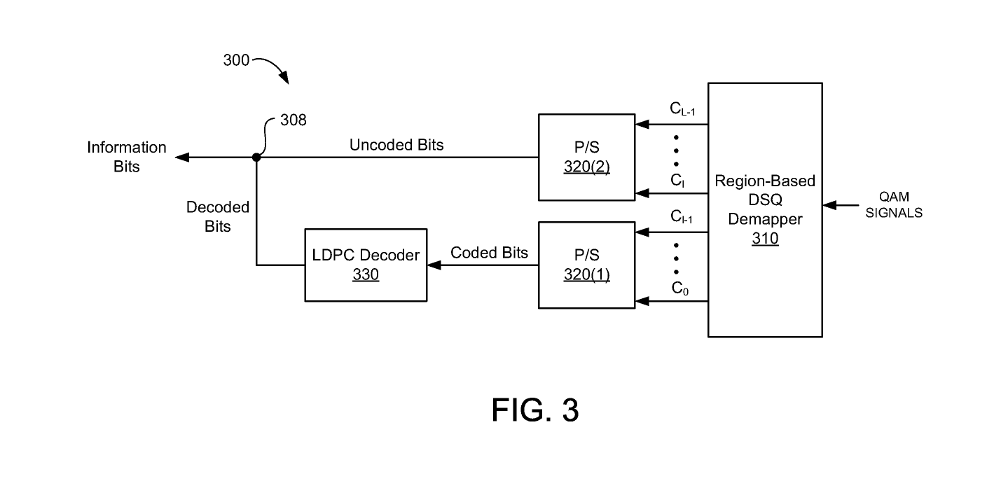

FIG. 3 shows a block diagram of a receiver 300 with region-based DSQ demapping circuitry in accordance with some embodiments. The receiver 300 includes region-based DSQ demapper 310, a set of parallel-to-serial (P/S) converter modules 320(1)-320(2), and an LDPC decoder 330. The receiver 300 may receive a DSQ symbol (e.g., from a transmitting device) and recover the original information bits that were mapped to the received DSQ symbol. More specifically, the received DSQ symbol may map to a particular set of labeling bits (i.e., a constellation point) in a corresponding DSQ constellation.

The received DSQ symbol is provided to the region-based DSQ demapper 310, which performs a region-based DSQ demapping operation on the received DSQ symbol to recover a set of labeling bits C₀-C_{L-1}. More specifically, the demapper 310 may compare the received DSQ symbol to the plurality of constellation points of the DSQ constellation to determine corresponding LLR values. The demapper 310 may then select the constellation point with the highest likelihood of matching the received DSQ symbol, and output the set of labeling bits C₀-C_{L-1} that are associated with the selected constellation point.

For some embodiments, the demapper 310 may use a log likelihood ratio (LLR) approximation when comparing the received DSQ symbol to constellation points that are relatively close to the center of the DSQ constellation. As described in greater detail below, the LLR approximation may involve calculations (e.g., equations or formulas) that are relatively simple to implement in hardware. However, the accuracy of the LLR approximations may degrade when the DSQ symbol is compared to constellation points that are further and further from the center of the DSQ constellation. Thus, the demapper 310 may further use a lookup table when comparing the received DSQ symbol to constellation points that are at least a threshold distance away from the center of the DSQ constellation. As described in greater detail below, the lookup table may store a grid pattern which is used to interpolate LLRs for constellation points further from the center of the DSQ constellation.

A subset of the labeling bits (C₀-C_{I-1}) is provided to P/S converter module 320(1) and the remaining labeling bits are provided to P/S converter module 320(2). It should be noted that the labeling bits C₀-C_{I-1} correspond to a subset of the information bits that were LDPC-encoded (e.g., forming an LDPC codeword) prior to transmission. The labeling bits C_{I}-C_{L-1} thus correspond to the subset of information bits that were left unencoded. For some embodiments, the subset of labeling bits C₀-C_{I-1} may represent the I least significant bits of the received DSQ symbol, and the remaining labeling bits C_{I}-C_{L-1} may represent the L-I most significant bits of the DSQ symbol.

The P/S module 320(1) converts the labeling bits C₀-C_{I-1} to a serial bit stream of coded information bits which is subsequently provided to the LDPC decoder 330. The LDPC decoder 330 performs an LDPC decoding operation on one or more sets of labeling bits C₀-C_{I-1} to recover a corresponding subset of information bits (e.g., the decoded bits). For example, an LDPC decoding operation may be used to verify the validity of the I labeling bits C₀-C_{I-1} by iteratively performing parity check operations based on an LDPC code (or using an LDPC parity check matrix). Through LDPC decoding, the LDPC decoder 330 may correct bit errors that are found in the labeling bits C₀-C_{I-1} based on the LDPC code.

The P/S module 320(2) converts the labeling bits C_{I}-C_{L-1} to a serial bit stream of unencoded information bits. More specifically, the P/S module 320(2) may convert one or more sets of labeling bits C_{I}-C_{L-1} to recover the original subset of information bits that were not encoded prior to transmission. A combiner 308 combines the unencoded information bits from the P/S module 320(2) with the decoded information bits from the LDPC decoder 330, in sequence, to reproduce the original data stream.

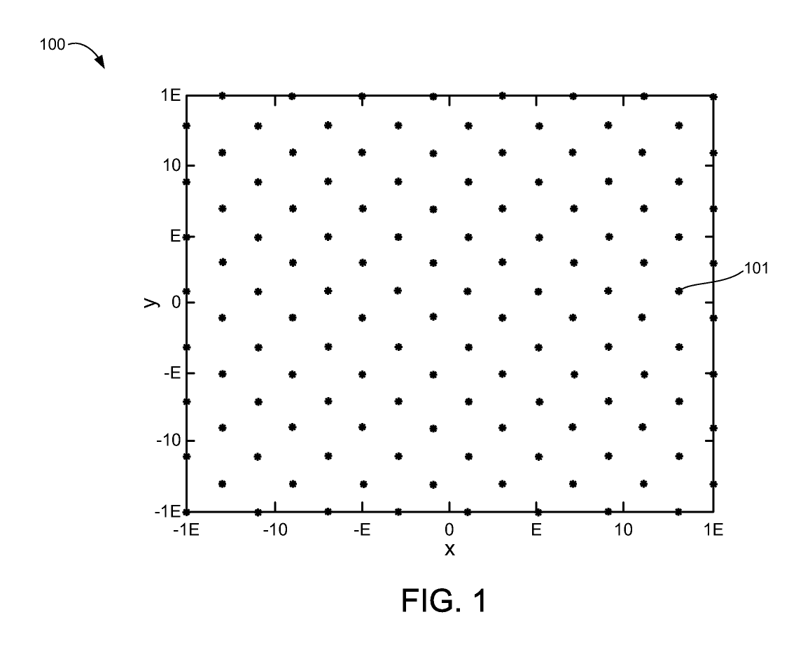

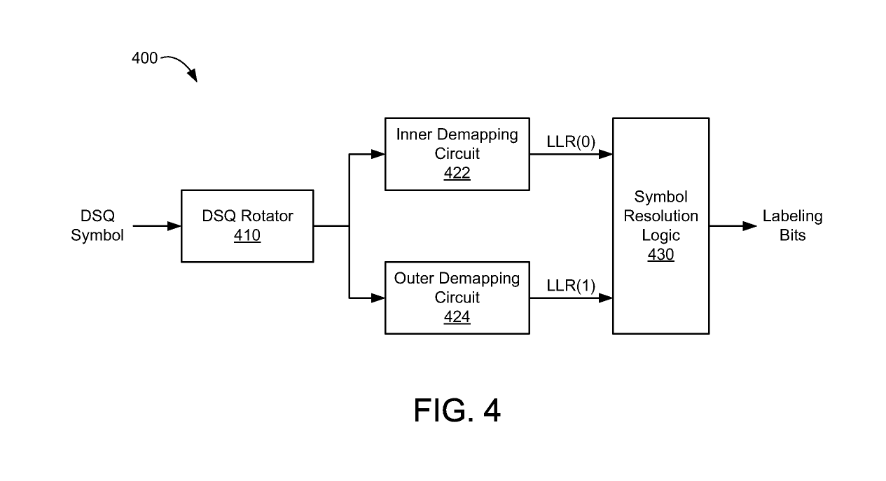

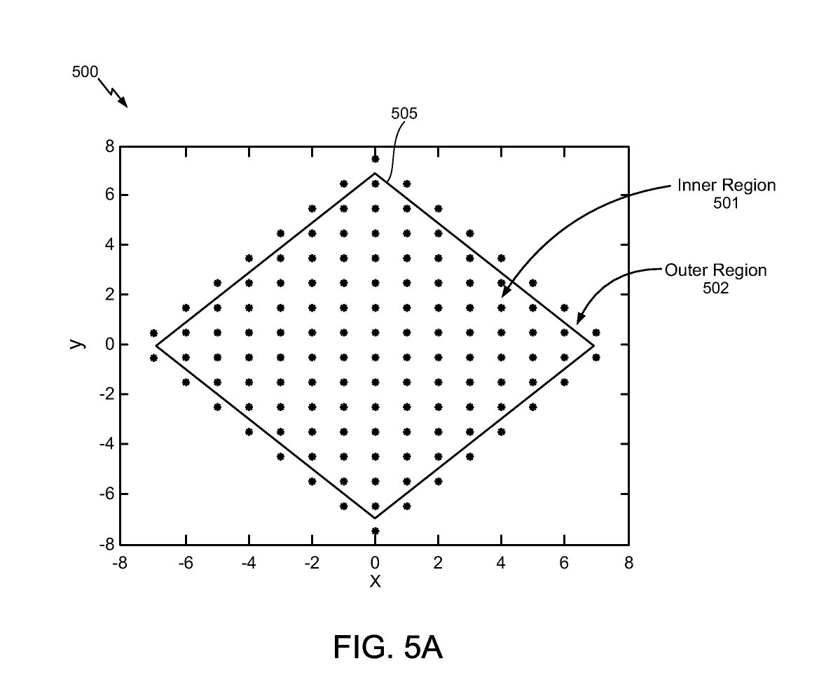

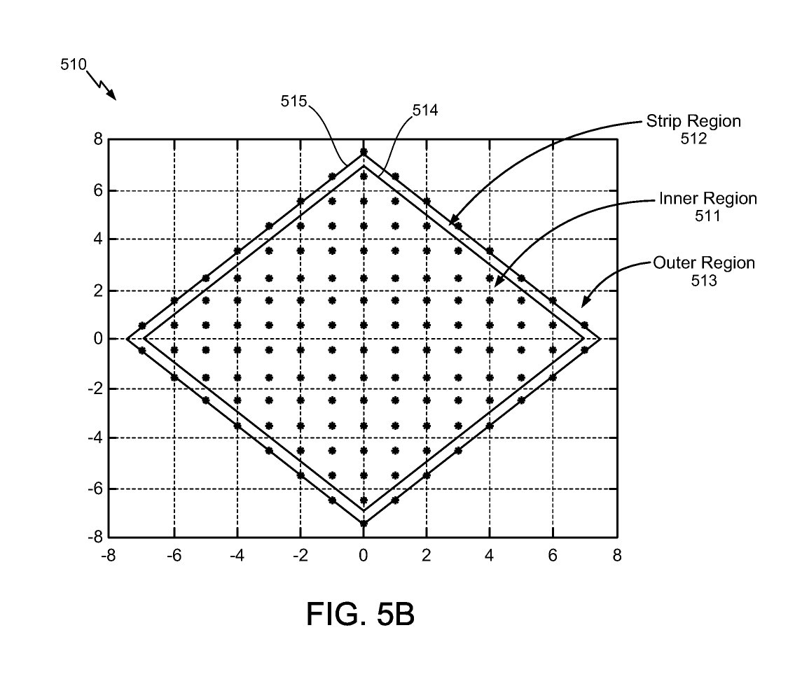

FIG. 4 shows a block diagram of a region-based DSQ demapper 400 in accordance with some embodiments. The demapper 400 includes a DSQ rotator 410, an inner demapping circuit 422, an outer demapping circuit 424, and symbol resolution logic 430. In accordance with present embodiments, the region-based DSQ demapper 400 demaps a received DSQ symbol to a set of labeling bits based on a rotated version of the DSQ constellation that is associated with the received DSQ symbol (e.g., to simplify LLR calculations). For example, FIG. 5A shows an exemplary DSQ constellation 500 that is a rotated version of the original DSQ constellation 100 shown in FIG. 1. For some embodiments, the DSQ constellation 500 may be achieved by rotating the DSQ constellation 100 by 90 degrees. Accordingly, the rotated signal space (x′, y′) associated with the DSQ constellation 500 may be defined as:

x′=(x−y)/4

y′=(x+y)/4

where (x, y) represents the signal space of the original DSQ constellation 100. Thus, the 4 encoded labeling bits (d₀, d₁, d₂, d₃) associated with each constellation point may be determined based on the following equations:

d₀=(x′)mod 4

d₁=(x′+1)mod 4

d₂=(y′)mod 4

d₃=(y′+1)mod 4

The DSQ rotator 410 receives a DSQ symbol and translates the received DSQ symbol to the rotated signal space. For example, the DSQ rotator 410 may rotate the received DSQ symbol by 90 degrees to coincide with constellation points of the rotated DSQ constellation 500. For some embodiments, the DSQ constellation 500 may correspond to a rotated version of a 128-DSQ constellation that is used for mapping and/or demapping labeling bits in 10GBASE-T Ethernet communications.

For some embodiments, the rotated DSQ constellation 500 is subdivided into at least two regions, including an inner region 501 and an outer region 502. More specifically, the inner region 501 and outer region 502 may be delineated (e.g., separated) by a square 505. For example, the square 505 may be defined by: |x′±y′|=7. Accordingly, the inner region 501 includes the constellation points that lie within the boundary of the square 505 (i.e., {|x′−y′|<7 &&|x′+y′|<7}), and the outer region 502 includes the remaining constellation points that fall outside of the corresponding square 505 (i.e., {|x′−y′|>7 ∥|x′+y′|>7}). For some embodiments, different techniques may be used for comparing the rotated DSQ symbol to constellation points of the inner region 501 and to constellation points of the outer region 502.

The inner demapping circuit 422 may determine a set of LLRs (LLR(0)) for constellation points of the inner region 501. For some embodiments, the inner demapping circuit 422 may use a max-log algorithm to approximate LLRs for the constellation points of the inner region 501. For example, the set of LLRs may be calculated (e.g., approximated) in a piecewise manner, based on the following set of equations:

$$LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix} \qquad ( 2 )$$

where dᵢ represents the i^{th} coded bit of a corresponding constellation point of the DSQ constellation 500. A more detailed description and derivation of the max-log algorithm above (i.e., Equation 2) can be found, for example, in “10GBASE-T Coding and Modulation: 128-DSQ+LDPC” by Gottfried Ungerboeck, presented to the IEEE P802. an Task Force in September 2004.

It should be noted that, while the max-log approximations allow for relatively simple hardware implementation, the accuracy of these approximations degrades when calculating LLRs for constellation points beyond the boundary defined by the square 505 (i.e., constellation points belonging to the outer region 502). To help illustrate this point, reference is herein made to FIG. 5B, which shows the DSQ constellation 500 further subdivided into three regions, including an inner region 511, a strip region 512, and an outer region 513. The regions are delineated by squares 514 and 515. For example, square 514 may be defined as: |x′±y′|=7; and square 515 may be defined as: |x′±y′|=7.5. Accordingly, the inner region 511 includes the constellation points that lie within the boundary of square 514 (i.e., {|x′−y′|<7 && |x′+y′|<7}); the strip region 512 includes the constellation points that fall between the boundaries of square 514 and square 515 (i.e., {|x′−y′|<7.5 &&|x′+y′|<7.5 &&(|x′−y′|>7 ∥|x′+y′|>7)}); and the outer region 513 includes the remaining constellation points that lie beyond square 515 (i.e., {|x′−y′|>7 ∥|x′+y′|>7}).

An error ratio may be defined as:

$$ErrRatio = \frac{mean \vert exact LLR - approximate LLR}{mean \vert exact LLR \vert}$$

Thus, using the max-log approximation (Equation 2) to calculate LLRs within the strip region 512 yields an error ratio of 23%. Moreover, using the max-log approximation to calculate LLRs for the outer region 513 yields a significantly greater error ratio of 43%.

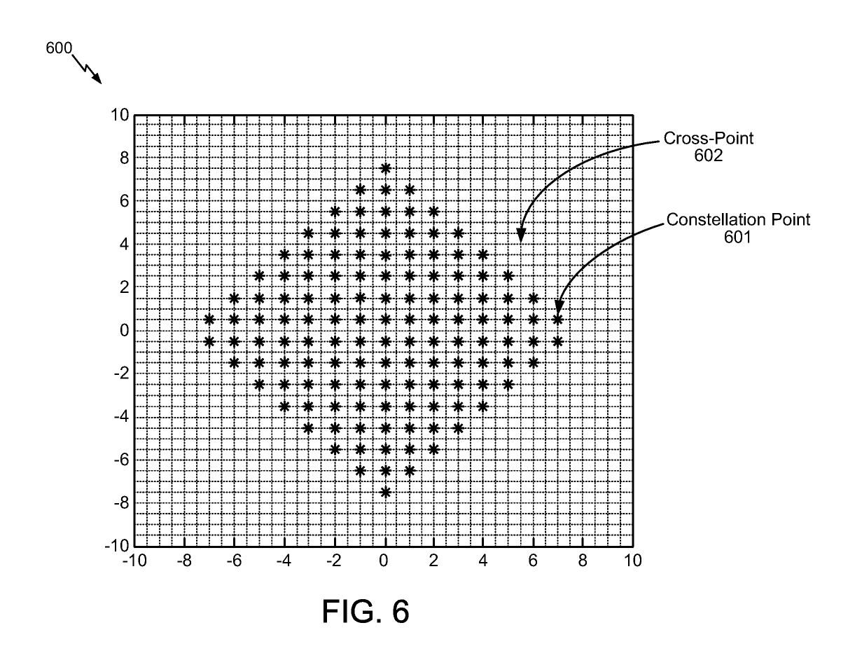

The outer demapping circuit 424 may thus determine a set of LLRs (LLR(1)) for constellation points of the outer region 502 using a different technique than that used by the inner demapping circuit 422. For some embodiments, the outer demapping circuit 424 may use a lookup table to interpolate the LLRs for constellation points that lie beyond the boundary of the square 505. For example, FIG. 6 illustrates an exemplary grid pattern 600 that may be used to generate a lookup table in accordance with some embodiments. Each constellation point 601 coincides with a cross-point 602 of the grid pattern 600, which may be stored in a lookup table. Thus, given a particular signal-to-noise ratio (SNR), the LLRs for the 4 coded bits associated with a constellation point of the DSQ constellation 500 may be calculated at discrete cross-points 602.

For some embodiments, when a received DSQ symbol falls within a particular grid of the grid pattern 600, the corresponding LLR may be calculated as a two-dimensional interpolation of four cross-point values. For some embodiments, the two-dimensional interpolation may be a two-dimensional linear interpolation. For example, assume that the received signal (x′, y′) falls within a grid associated with the four cross-points: (aᵢ, bⱼ), (aᵢ₊₁, bⱼ), (aᵢ, bⱼ₊₁), and (aᵢ₊₁, bⱼ₊₁), where aᵢ<aᵢ₊₁ and bᵢ<bᵢ₊₁. The corresponding LLRs associated with those cross-points may be denoted: LLR(i, j), LLR(i+1, j), LLR(i, j+1), LLR(i+1, j+1), respectively. Then the LLR of the received signal (x′, y′) may be expressed by the following equation:

$$LLR ( {x}^{′} , {y}^{′} ) = \frac{\{ \begin{matrix}( {x}^{′} - {a}_{i} ) * LLR ( i + 1 , j ) + \\ ( {a}_{i + 1} - {x}^{′} ) * LLR ( i , j )\end{matrix} \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )} \qquad ( 3 )$$

It should be noted that, while the foregoing LLR equation (i.e, Equation 3) may represent a two-dimensional linear interpolation of four cross-point values, other variations may exist. For example, in other embodiments, the LLRs may be interpolated in a non-liner fashion (e.g., using the same four cross-point values).

The symbol resolution logic 430 outputs a set of labeling bits based on the LLRs determined by the inner demapping circuit 422 (i.e., LLR(0)) with the LLRs determined by the outer demapping circuit 424 (i.e., LLR(1)). For example, the symbol resolution logic 430 may compare LLR(0) with LLR(1) to determine which constellation point of the DSQ constellation 500 most closely matches the received DSQ symbol. The symbol resolution logic 430 may then output the set of labeling bits (e.g., C₀-C_{L-1}) that map to the closest matching constellation point.

It should be noted that the LLR equation implemented by the outer demapping circuit 424 (i.e., Equation 3) is much simpler to implement (e.g., solve) than the exact LLR equation (i.e., Equation 1) described previously. Moreover, because the grid pattern 600 may be stored in a lookup table, this LLR calculation may be more easily implemented in high speed Ethernet hardware (e.g., than conventional LLR calculation techniques). Accordingly, the region-based demapper 400 provides an efficient technique for demapping a received DSQ symbol to constellation points of a DSQ constellation 500 that is accurate for calculating LLRs in both the inner region 501 and the outer region 502 of the constellation 500.

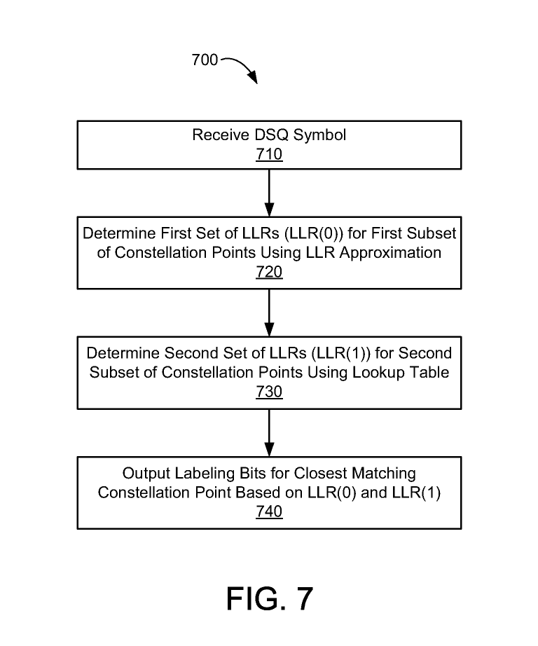

FIG. 7 is an illustrative flow chart depicting an exemplary region-based DSQ demapping operation 700 in accordance with some embodiments. In one example, with reference to FIG. 4, the demapper 400 first receives a DSQ symbol to be demapped (710). For some embodiments, the demapping operation 700 may be performed based on a rotated version of the DSQ constellation associated with the received DSQ symbol. Thus, the DSQ rotator 410 may rotate the received DSQ symbol (e.g., by 90 degrees) to coincide with constellation points of the rotated DSQ constellation.

The demapper 400 determines a first set of LLRs for a first subset of the constellation points using an LLR approximation (720). The first subset of constellation points may correspond to those constellation points that are closer to (e.g., within a threshold range of) the center of the DSQ constellation. For example, the first subset of constellation points may be bounded within a square region of the DSQ constellation (e.g., within inner region 501 shown in FIG. 5A). For some embodiments, the inner demapping circuit 422 may determine the first set of LLRs using a max-log algorithm (e.g., Equation 2) to approximate LLRs for the first subset of constellation points.

The demapper 400 determines a second set of LLRs for a second subset of constellation points using a lookup table (730). The second subset of constellation points may correspond to those constellation points that are further from (e.g., beyond the threshold range of) the center of the DSQ constellation. For example, the second subset of constellation points may fall outside the square region of the DSQ constellation (e.g., within outer region 502 shown in FIG. 5B). For some embodiments, the outer demapping circuit 424 may store a grid pattern that may be used to interpolate LLRs for the second subset of constellation points (e.g., as described above with respect to FIG. 6). More specifically, each of the second set of LLRs may be calculated through two-dimensional interpolation of the four cross-points in the grid that are closest to the received DSQ symbol (e.g., Equation 3).

Finally, the demapper 400 may output a set of labeling bits that correspond to the closest-matching constellation point identified based on the first and second sets of LLRs (740). For example, the symbol resolution logic 430 may compare the first set LLRs with the second set of LLRs to determine which constellation point of the corresponding DSQ constellation most closely matches the received DSQ symbol. The symbol resolution logic 430 may then output the labeling bits that are mapped to the closest-matching constellation point.

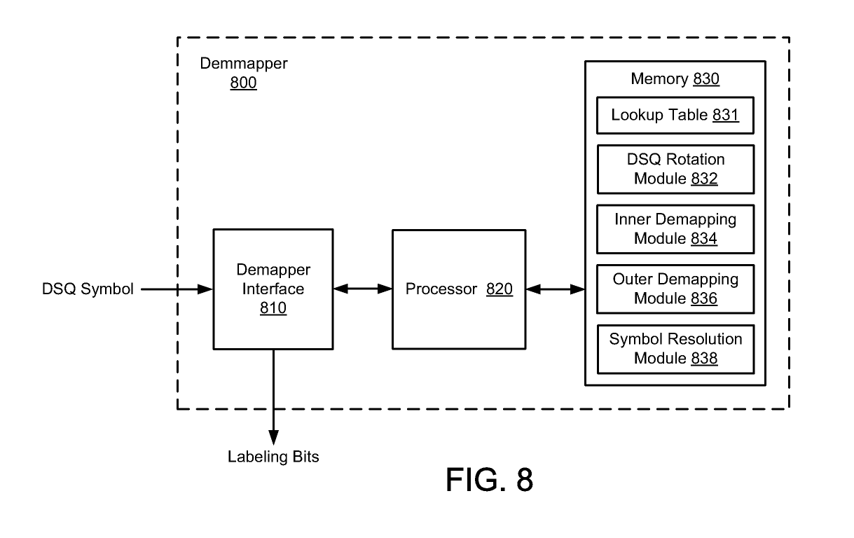

FIG. 8 is a block diagram of a demapper 800 in accordance with some embodiments. The demapper 800 includes a demapper interface 810, a processor 820, and memory 830. The demapper interface 810 may be used for communicating data to and/or from the demapper 800. For example, the demapper interface 810 may receive a DSQ symbol (e.g., from another device in a network) to be demapped to a set of labeling bits. The demapper interface 810 may also output labeling bits generated by the processor 820, for example, to a central processing unit (CPU). For some embodiments, the demapper 800 may perform demapping operations based on a rotated version of the DSQ constellation associated with the received DSQ symbol.

Memory 830 may include a lookup table 831 that may store a grid pattern used for interpolating LLRs for constellation points of a DSQ constellation. Furthermore, memory 830 may also include a non-transitory computer-readable storage medium (e.g., one or more nonvolatile memory elements, such as EPROM, EEPROM, Flash memory, a hard drive, etc.) that can store the following software modules:
a DSQ rotation module 832 to rotate the received DSQ symbol to coincide with constellation points of the rotated DSQ constellation;
an inner demapping module 834 to determine LLRs for a first subset of the constellation points of the rotated DSQ constellation;
an outer demapping module 836 to determine LLRs for a second subset of the constellation points of the rotated DSQ constellation; and
a symbol resolution module 838 to generate a set of labeling bits based on the LLRs for the first and second subsets of constellation points.
   Each software module may include instructions that, when executed by the processor 820, may cause the demapper 800 to perform the corresponding function. Thus, the non-transitory computer-readable storage medium of memory 830 may include instructions for performing all or a portion of the operations described above with respect to FIG. 7.

The processor 820, which is coupled between the demapper interface 810 and the memory 830, may be any suitable processor capable of executing scripts of instructions of one or more software programs stored in the demapper 800 (e.g., within memory 830). For example, the processor 820 may execute the DSQ rotation module 832, the inner demapping module 834, the outer demapping module 836, and/or the symbol resolution module 838.

The DSQ rotation module 832 may be executed by the processor 820 to rotate the received DSQ symbol to coincide with constellation points of the rotated DSQ constellation. For example, the DSQ rotation module 832, as executed by the processor 820, may rotate the received DSQ symbol to coincide with constellation points of the rotated DSQ constellation implemented by the inner demapping module 834 and the outer demapping module 836. For some embodiments, the processor 820, in executing the DSQ rotation module 832, may rotate the received DSQ symbol by 90 degrees.

The inner demapping module 834 may be executed by the processor 820 to determine LLRs for a first subset of the constellation points of the rotated DSQ constellation. For some embodiments, the processor 820, in executing the inner demapping module 834, may generate the LLRs for the first subset of constellation points based on an LLR approximation (e.g., Equation 2). For example, the inner demapping module 834, as executed by the processor 820, may approximate the LLRs for constellation points bounded within a square region of the DSQ constellation (e.g., inner region 501 shown in FIG. 5A).

The outer demapping module 836 may be executed by the processor 820 to determine LLRs for a second subset of the constellation points of the rotated DSQ constellation. For some embodiments, the processor 820, in executing the outer demapping module 836, may generate the LLRs for the second subset of constellation points based on a two-dimensional interpolation (e.g., Equation 3). For example, the outer demapping module 836, as executed by the processor 820, may use the grid pattern stored by the lookup table 831 to interpolate the LLRs for constellation points outside the square region of the DSQ constellation (e.g., outer region 502 shown in FIG. 5B).

The symbol resolution module 838 may be executed by the processor 820 to generate a set of labeling bits based on the LLRs for the first and second subsets of constellation points. For example, the symbol resolution module 838, as executed by the processor 820, may compare the LLRs generated by the inner demapping module 834 with the LLRs generated by the outer demapping module 836 to determine which constellation point of the corresponding DSQ constellation most closely matches the received DSQ symbol. The processor, in executing the symbol resolution module 838, may then output the labeling bits that are mapped to the closest-matching constellation point.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow chart of FIG. 7 may be performed in other suitable orders, multiple steps may be combined into a single step, and/or some steps may be omitted. In another example, while modules in FIG. 8 are depicted as software in memory 830, any of the modules may be implemented in hardware, software, firmware, or a combination of the foregoing.

What is claimed is:

1. A method for demapping a double squared quadrature amplitude modulated (DSQ) symbol, the method comprising:
determining one or more first log likelihood ratios (LLRs) for a first subset of constellation points of a corresponding DSQ constellation using an LLR approximation;
determining one or more second LLRs for a second subset of constellation points of the DSQ constellation based on an interpolation; and
demapping the DSQ symbol to one of a plurality of constellation points of the DSQ constellation using at least one of the one or more first LLRs and at least one of the one or more second LLRs.

2. The method of claim 1, wherein the first subset of constellation points corresponds with an inner region of the DSQ constellation, and wherein the second subset of constellation points corresponds with an outer region of the DSQ constellation.

3. The method of claim 2, further comprising:
rotating a signal space (x, y) associated with the DSQ constellation; and
wherein the rotated signal space (x′, y′) is defined as: x′=(x−y)/4 and y′=(x+y)/4.

4. The method of claim 3, wherein the DSQ constellation is a 128-DSQ constellation for 10GBASE-T Ethernet.

5. The method of claim 4, wherein the inner and outer regions of the DSQ constellation are delineated by: |x′±y′|=7.

6. The method of claim 3, wherein the LLR approximation is a max-log LLR approximation.

7. The method of claim 6, wherein determining the one or more first
$$LLRs further comprises \text{:} LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix} .$$

8. The method of claim 3, wherein determining the one or more second LLRs includes:
retrieving information identifying a two-dimensional grid pattern from a lookup table;
wherein each of the plurality of constellation points of the DSQ constellation coincides with a cross-point of the grid pattern.

9. The method of claim 8, wherein determining the one or more second LLRs comprises:
identifying a particular grid of the two-dimensional grid pattern based on the DSQ symbol, wherein the particular grid is defined by four cross-points of the two-dimensional grid pattern;
performing a two-dimensional interpolation of the four cross-points that define the particular grid; and
calculating the one or more LLRs based on the two-dimensional interpolation.

10. The method of claim 9, wherein the two-dimensional interpolation includes at least one of a linear interpolation or a bilinear interpolation.

11. The method of claim 9, wherein determining the one or more second LLRs comprises:
$$LLR ( {x}^{′} , {y}^{′} ) = \frac{\{ ( {x}^{′} - {a}_{i} ) * LLR ( i + 1 , j ) + ( {a}_{i + 1} - {x}^{′} ) * LLR ( I , j ) \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )} .$$

12. A computer-readable storage medium containing program instructions that, when executed by a processor provided within a communications device, causes the device to:
determine one or more first LLRs for a first subset of constellation points of a DSQ constellation using an LLR approximation;
determine one or more second LLRs for a second subset of constellation points of the DSQ constellation based on an interpolation; and
demap a received DSQ symbol to one of a plurality of constellation points of the DSQ constellation using at least one of the one or more first LLRs and at least one of the one or more second LLRs.

13. The computer-readable storage medium of claim 12, wherein the first subset of constellation points corresponds with an inner region of the DSQ constellation, and wherein the second subset of constellation points corresponds with an outer region of the DSQ constellation.

14. The computer-readable storage medium of claim 13, further comprising program instructions that cause the device to:
rotate a signal space (x, y) associated with the DSQ constellation; and
wherein the rotated signal space (x′, y′) is defined as: x′=(x−y)/4 and y′=(x+y)/4.

15. The computer-readable storage medium of claim 14, wherein the DSQ constellation is a 128-DSQ constellation for 10GBASE-T Ethernet.

16. The computer-readable storage medium of claim 15, wherein the inner and outer regions of the DSQ constellation are delineated by: |x′±y′|=7.

17. The computer-readable storage medium of claim 14, wherein the LLR approximation is a max-log LLR approximation.

18. The computer-readable storage medium of claim 17, wherein execution of the program instructions to determine the one or more first LLRs causes the device to compute:
$$LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix} .$$

19. The computer-readable storage medium of claim 14, wherein execution of the program instructions to determine the one or more second LLRs causes the device to:
retrieve information identifying a two-dimensional grid pattern from a lookup table;
wherein each of the plurality of constellation points of the DSQ constellation coincides with a cross-point of the grid pattern.

20. The computer-readable storage medium of claim 19, wherein execution of the program instructions to determine the one or more second LLRs causes the device to:
identify a particular grid of the two-dimensional grid pattern based on the DSQ symbol, wherein the particular grid is defined by four cross-points of the two-dimensional grid pattern;
perform a two-dimensional interpolation of the four cross-points that define the particular grid; and
calculate the one or more LLRs based on the two-dimensional interpolation.

21. The computer-readable storage medium of claim 20, wherein the two-dimensional interpolation includes at least one of a linear interpolation or a bilinear interpolation.

22. The computer-readable storage medium of claim 20, wherein execution of the program instructions to determine the one or more second LLRs further causes the device to compute:
$$LLR ( {x}^{′} , {y}^{′} ) = \frac{\{ ( {x}^{′} - {a}_{i} ) * LLR ( i + 1 , j ) + ( {a}_{i + 1} - {x}^{′} ) * LLR ( I , j ) \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )} .$$

23. A receiver circuit to receive a DSQ symbol, the receiver circuit comprising:
a first demapping circuit to determine one or more first LLRs for a first subset of constellation points of a DSQ constellation using an LLR approximation;
a second demapping circuit to determine one or more second LLRs for a second subset of constellation points of the DSQ constellation based on an interpolation; and
symbol resolution logic to demap the DSQ symbol to one of a plurality of constellation points of the DSQ constellation using at least one of the one or more first LLRs and at least one of the one or more second LLRs.

24. The receiver circuit of claim 23, wherein the first subset of constellation points corresponds with an inner region of the DSQ constellation, and wherein the second subset of constellation points corresponds with an outer region of the DSQ constellation.

25. The receiver circuit of claim 24, further comprising:
a DSQ rotator to rotate a signal space (x, y) associated with the DSQ constellation;
wherein the rotated signal space (x′, y′) is defined as: x′=(x−y)/4 and y′=(x+y)/4.

26. The receiver circuit of claim 25, wherein the DSQ constellation is a 128-DSQ constellation for 10GBASE-T Ethernet.

27. The receiver circuit of claim 26, wherein the inner and outer regions of the DSQ constellation are delineated by: |x′±y′|=7.

28. The receiver circuit of claim 25, wherein the LLR approximation is a max-log LLR approximation.

29. The receiver circuit of claim 28, wherein the first demapping circuit is to determine the one or more first LLRs by computing:
$$LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix} .$$

30. The receiver circuit of claim 25, further comprising:
a lookup table to store information identifying a two-dimensional grid pattern;
wherein each of the plurality of constellation points coincides with a cross-point of the grid pattern.

31. The receiver circuit of claim 30, wherein the second demapping circuit is to determine the one or more second LLRs by:
identifying a particular grid of the two-dimensional grid pattern based on the DSQ symbol, wherein the particular grid is defined by four cross-points of the two-dimensional grid pattern;
performing a two-dimensional interpolation of the four cross-points that define the particular grid; and
calculating the one or more LLRs based on the two-dimensional interpolation.

32. The receiver circuit of claim 31, wherein the two-dimensional interpolation includes at least one of a linear interpolation or a bilinear interpolation.

33. The receiver circuit of claim 31, wherein the second demapping circuit is to determine the one or more second LLRs by computing:
$$LLR ( {x}^{′} , {y}^{′} ) = \frac{\{ ( {x}^{′} - {a}_{i} ) * LLR ( i + 1 , j ) + ( {a}_{i + 1} - {x}^{′} ) * LLR ( I , j ) \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )} .$$

34. A receiver circuit to receive a DSQ symbol, the receiver circuit comprising:
means for determining one or more first LLRs for a first subset of constellation points of a corresponding DSQ constellation using an LLR approximation;
means for determining one or more second LLRs for a second subset of constellation points of the DSQ constellation based on an interpolation; and
means for demapping the DSQ symbol to one of a plurality of constellation points of the DSQ constellation using at least one of the one or more first LLRs and at least one of the one or more second LLRs.

35. The receiver circuit of claim 34, wherein the first subset of constellation points corresponds with an inner region of the DSQ constellation, and wherein the second subset of constellation points corresponds with an outer region of the DSQ constellation.

36. The receiver circuit of claim 35, further comprising:
means for rotating a signal space (x, y) associated with the DSQ constellation; and
wherein the rotated signal space (x′, y′) is defined as: x′=(x−y)/4 and y′=(x+y)/4.

37. The receiver circuit of claim 36, wherein the DSQ constellation is a 128-DSQ constellation for 10GBASE-T Ethernet.

38. The receiver circuit of claim 37, wherein the inner and outer regions of the DSQ constellation are delineated by: |x±y′|=7.

39. The receiver circuit of claim 36, wherein the LLR approximation is a max-log LLR approximation.

40. The receiver circuit of claim 39, wherein the means for determining the one or more first LLRs comprises means for computing:
$$LLR ( i ) = \{ \begin{matrix}{d}_{i} + 0.5 , & 0 \leq {d}_{i} + 0.5 < 0.5 \\ 1.5 - {d}_{i} , & 0.5 \leq {d}_{i} + 0.5 < 2.5 \\ {d}_{i} - 3.5 , & 2.5 \leq {d}_{i} + 0.5 < 4\end{matrix} .$$

41. The receiver circuit of claim 36, wherein the means for determining the one or more second LLRs includes:
means for retrieving information identifying a two-dimensional grid pattern from a lookup table;
wherein each of the plurality of constellation points of the DSQ constellation coincides with a cross-point of the grid pattern.

42. The receiver circuit of claim 41, wherein the means for determining the one or more second LLRs comprises:
means for identifying a particular grid of the two-dimensional grid pattern based on the DSQ symbol, wherein the particular grid is defined by four cross-points of the two-dimensional grid pattern;
means for performing a two-dimensional interpolation of the four cross-points that define the particular grid; and
means for calculating the one or more LLRs based on the two-dimensional interpolation.

43. The receiver circuit of claim 42, wherein the two-dimensional interpolation includes at least one of a linear interpolation or a bilinear interpolation.

44. The receiver circuit of claim 42, wherein the means for determining the one or more second LLRs comprises means for computing:
$$LLR ( {x}^{′} , {y}^{′} ) = \frac{\{ ( {x}^{′} - {a}_{i} ) * LLR ( i + 1 , j ) + ( {a}_{i + 1} - {x}^{′} ) * LLR ( I , j ) \} * ( {b}_{j + 1} - {y}^{′} )}{( {a}_{i + 1} - {a}_{i} ) ( {b}_{j + 1} - {b}_{j} )} + \frac{\{ \begin{matrix}( {x}^{′} - {a}_{i} ) * LLR ( i + 1 , j + 1 ) + \\ ( {a}_{i + 1} - {x}^{′} ) * LLR ( i , j + 1 )\end{matrix} \} * ( {y}^{′} - {b}_{j} )}{( {a}_{i + 1} - {a}_{i} ) ( {b}_{j + 1} - {b}_{j} )} .$$
